(19) United States
(12) Patent Application Publication
(10) Pub. No.: US 2016/0189175 A1
(43) Pub. Date: Jun. 30, 2016

(54) SYSTEM AND METHOD OF SENSITIVITY-DRIVEN PRICING SERVICE FOR NON-STATIONARY DEMAND MANAGEMENT

(71) Applicants: Hanshuang LI, Pittsburgh, PA (US); Gufei SUN, Shanghai (CN); Yu CHENG, Shanghai (CN); Yongyuan SHEN, Shanghai (CN); Heng WANG, Shanghai (CN); Wen-Syan LI, Shanghai (CN)

(72) Inventors: Hanshuang LI, Pittsburgh, PA (US); Gufei SUN, Shanghai (CN); Yu CHENG, Shanghai (CN); Yongyuan SHEN, Shanghai (CN); Heng WANG, Shanghai (CN); Wen-Syan LI, Shanghai (CN)

(21) Appl. No.: 14/582,193

(22) Filed: Dec. 24, 2014

(51) Int. Cl. G06Q 30/02

(52) U.S. Cl. CPC G06Q 30/0202; G06Q 30/0206

(57) ABSTRACT

Disclosed herein are technologies for demand management by providing a real time prediction model, using an elasticity matrix to quantify price change and demand, group customers based on their demand, set pricing per each group of customers, and optimize distribution. This Abstract is submitted with the understanding that it will not be used to interpret or limit the scope or meaning of the claims.

### TECHNICAL FIELD

The present disclosure relates generally to forecasting user demand for goods and services using price elasticity model and user price sensitivity.

### BACKGROUND

Many service related industries experience non-stationary demand from the customers or end-users. For example, public utilities such as electricity, water, gas, etc. may experience user consumption influenced by seasonal characteristics. Therefore corresponding demand for services goes up and down over the year. Another example is retail industry, where demand of certain merchandise may be influenced by a number of factors such as weather, market activities, and the macro-economic environment. Therefore, demand for goods fluctuates from time to time.

In many cases, the pricing of a service plays an important role in non-stationary demand management to help regulate and control the market. Take for example public utility demand. Many public utilities are capital intensive, with a major cost from initial fixed investments. Since the initial investment is usually determined by a predicted demand, the bigger the gap between the high and low customer demands, the lower profit margin. For utilities that supply key public resources such as water and electricity, a large gap can bring high system risk and resource waste.

Demand management may experience problems in predicting demand and manipulate demand. Demand may be influenced by many factors that are difficult forecast. Different customers have different reactions as to varying polices. A demand change for a customer at one point in time may affect the customer's demand at another point in time.

### SUMMARY

Disclosed herein are technologies for demand management using a real time prediction model, and an elasticity matrix to quantify price change and customer demand.

In accordance with one aspect, a computer-implemented method for demand management is disclosed. The method includes generating demand vectors of consumers by a demand model module. Price elasticity matrices are calculated for consumers by a pricing model unit. Consumers are grouped into consumer groups based on price elasticity matrices. Representative price elasticity matrices are generated for the consumer groups. An optimizing function is constructed. The optimizing function is solved to produce price vectors to set pricing for the consumer groups to manage demand based on pricing.

In accordance with another aspect, a demand management system includes a demand prediction module. The demand prediction module includes a multiple regression model unit to generate demand vectors predicting demand of consumers. A pricing model module includes a consumer grouping unit which groups consumers into consumer groups based on individual price elasticity matrices and calculates representative price elasticity matrices for the consumer groups. An optimization module, the optimization module includes an optimizer unit for solving an optimizing function to generate price vectors to set pricing for the consumer groups to manage demand based on pricing.

In accordance with another aspect, a non-transitory computer-readable medium having stored thereon program code which is executable by a computer for providing demand management based on pricing is disclosed. The code generates demand vectors of consumers for a next period of time by a demand model module with a multiple regression module unit of the demand model module. Price elasticity matrices for consumers by a pricing model unit are calculated. Consumers are group into consumer groups based on price elasticity matrices. Representative price elasticity matrices are calculated for the consumer groups. An optimizing function is calculated. The function is solved to produce price vectors to set pricing for the consumer groups for time slots in the next period of time to manage demand based on pricing.

With these and other advantages and features that will become hereinafter apparent, further information may be obtained by reference to the following detailed description and appended claims, and to the figures attached hereto.

### BRIEF DESCRIPTION OF THE DRAWINGS

FIG. 1 illustrates an exemplary system;

FIG. 2 illustrates an exemplary demand over time curve;

FIG. 3 illustrates an exemplary process for Genetic Algorithm;

FIG. 4 illustrates an exemplary process for initialization;

FIG. 5 illustrates an exemplary diagram of crossover and mutation;

FIG. 6 illustrates an exemplary process for demand management; and

FIG. 7 illustrates an exemplary computing system.

The Detailed Description references the accompanying figures. In the figures, the left-most digit(s) of a reference number identifies the figure in which the reference number first appears. The same numbers are used throughout the drawings to reference like features and components.

### DETAILED DESCRIPTION

Described herein are systems and methods for determining a demand plan and managing demand (demand management) for a product or service. For simplification, the term product may refer to either a product or a service which is consumed or used. A real-time demand prediction model is used to forecast demand. An elasticity matrix is used to quantize the reaction of consumers toward the change of price and the cross-impact between different consumer time points. Clustering of consumers (group) and setting price for each group of consumer is set. The elasticity matrix measures the price sensitivity of consumers and to analyze their consumption behavior once the price changes. Pricing is related as an optimization problem and optimizing algorithms are implemented to determine pricing. Demand management is determined and specific pricing is made for different types of users.

In determining pricing for non-stationary demand management for a product of interest, the following is performed: 1) accurately predicting the product consumption in a certain period of time, 2) clustering the consumers based on their sensitivity in price, and 3) making corresponding pricing strategy to optimize the total demand by smoothing the peaks in the demand of the product.

In the description, providing electricity to consumers is used as an example. However, it will be apparent that the systems and methods described may be applied to other goods and services. Various factors may affect demand of consumers, such as price, promotion, advertising, season, etc. One or several factors may be selected as variables in determining a demand plan.

For example, in determining pricing for non-stationary demand management for electricity, the following is performed: 1) accurately predicting the electricity consumption in a certain period of time, 2) clustering the consumers based on their sensitivity in price, and 3) making corresponding pricing strategy to optimize the total demand and smooth the peak.

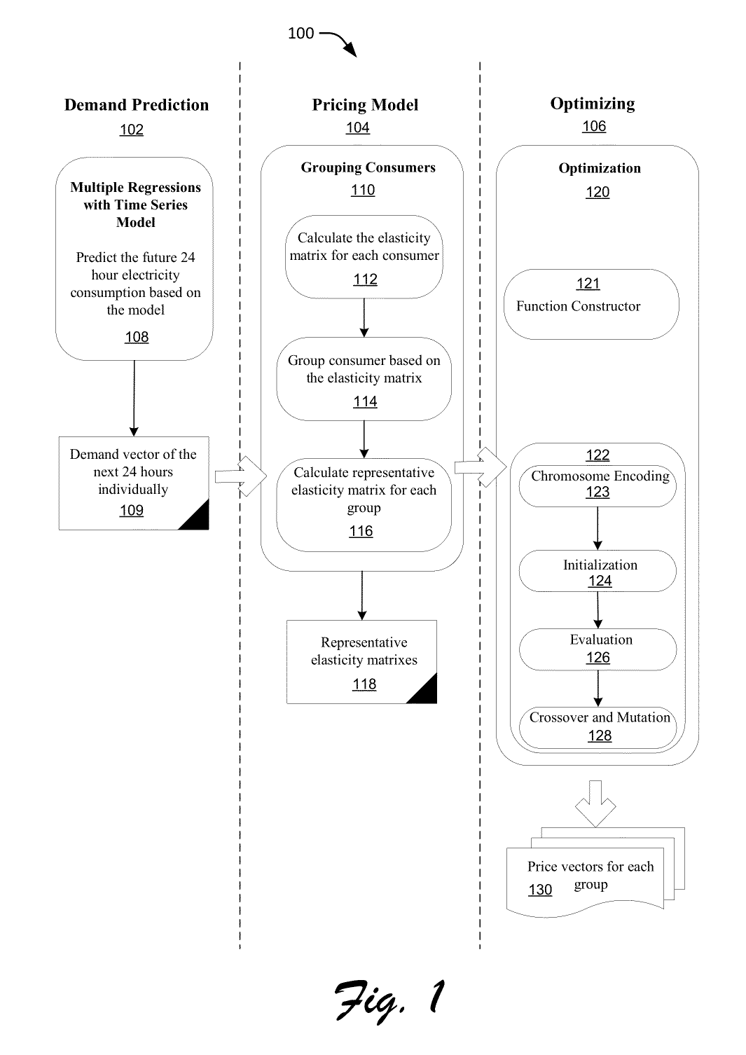

FIG. 1 shows an example of a system 100 for implementing the techniques describe herein. System 100, as shown, includes the following components: 1) a Demand Prediction module 102, 2) a Pricing Model module 104 and 3) an Optimization module 106.

The Demand Prediction module 102 includes a demand model unit 108. The multiple regression model unit 108 is used to predict the consumption of a product of interest of each customer for a next period of time based on historical consumption data. The next period of time may be, for example, the next 24 hours. Other lengths or durations may also be useful. For example, the next period may be next week, next month or other periods. As an example, the multiple regression model 108 unit is used to predict the consumption of electricity of each consumer in next 24 hours based on their historical consumption data. Predicting consumption of other types of goods or services for different next periods of time may also be useful. The multiple regression module unit generates demand vectors 109 of customers or consumers individually for the next period of time, such as the next 24 hours. The demand vectors are provided to the Pricing Model module 104. For example, the demand vectors are provided to the Pricing Model module 104.

The Pricing Model module 104 includes a consumer grouping unit 110. The consumer grouping unit includes an individual matrix generator 112, a consumer grouper 114 and a group matrix generator 116. The individual matrix generator calculates a price elasticity matrix for each consumer. The consumer grouper groups consumers based on the elasticity matrices of the consumers. The number of groups, for example, may be five. Other number of groups may also be useful. The group matrix generator calculates representative price elasticity matrices 118 for the consumer groups, using consumption information in the demand vectors 109. For example, a representative price elasticity matrix is generated for each consumer group over the next period of time. As an example, the representative elasticity matrix of each group and the electricity consumption is based over a proceeding 24 hour period. The representative elasticity matrices 118 are provided to the Optimizing module 106.

In the Optimizing Module 106, it includes an optimizer unit 120. The optimizer unit includes a function constructor 121 and an analyzer 122. The function constructor builds an optimizing function to minimize the demand fluctuations. The optimizing function, for example, is a quadratically constrained quadratic program (QCQP). The QCQP includes an objective function and the constraints are quadratic functions. The analyzer is used to solve the optimizing function.

In one implementation, the analyzer includes a heuristic analyzer for solving the optimizing function. The heuristic analyzer, for example, includes components for performing a Genetic Algorithm (GA) or analysis to solve the optimizing function. For example, the heuristic analyzer is a GA analyzer. Providing other types of analyzer using other processes, such as Branch and Bound (BB) algorithms or other types of heuristic algorithms may also be useful. The GA analyzer, in one implementation, includes an encoder 123, such as a chromosome encoder, an initializer 124, an evaluator 126 and a mutator 128. The optimizing module generates price vectors for each consumer group. The price vectors, for example, set pricing for each consumer group. The optimizing module smooth the consumer demand by controlling the price.

### Demand Prediction Module

As discussed above, the example of electricity consumption and demand is used; however, other consumption and demand for other goods and services may also be applicable.

In one implementation, the demand model of the Demand Prediction Module includes a statistical model. In one implementation, the demand module includes an autoregressive integrated moving average (ARIMA) time series regression model. The regression model is used to forecast or predict the electricity consumption in, for example, the proceeding/next 24 hours, taking into consideration the consumption time series, such as weather, time (weekday or weekend), special time (whether this is a festival or public holiday). Other factors may also be taken into consideration. To ensure the accuracy of the prediction, forecasting is performed for customers individually. Performing a sampling of the customers may also be useful. The following Equation 1 is used for the model:

y=β₀+β₁x₁+β₂x₂+β₃x₃+ . . . +βₘ₋₁xₘ₋₁+βₘxₘ+b₁xₘ₊₁+b ₂xₘ₊₂+b₃xₘ₊₃+e Equation 1

where

y is the predicted electricity consumption in the next time slot m+1,

x₁, x₂ . . . xₘ₋₁, xₘ are the electricity consumption in former m−1 time slots, and electricity consumption in present time slot,

xₘ, xₘ₊₁, xₘ₊₂ are weather condition, time and special time,

β₀, β₁, β₂ . . . βₘ₋₁, βₘ are regression coefficients of time slots,

b₁, b₂, b₃ are regression coefficients of weather, time and special time, and

e is the error.

Using this prediction model, a demand vector for next 24 hours of every consumer is developed. The demand vectors are passed to the Pricing Model Module.

### Pricing Model Module

The Pricing Model Module groups includes a consumer grouping unit. The consumer grouping unit includes an individual matrix generator, a consumer grouper and a group matrix generator.

In one implementation, the individual matrix generator calculates a price elasticity matrix for each consumer. The price elasticity matrices of the consumers may be calculated by historical data or by measured by experimentation. Other techniques for generating the price elasticity matrices may also be useful.

Price elasticity is used as an indicator to measuring price sensitivity of consumers. Generally, demand is negatively related to price, resulting in a negative slope demand curve. To simplify quantifying the demand curve, it is linearized around a given point. The price elasticity of demand is defined as the relative slope of demand curve using Equation 2:

$$ɛ = \frac{\frac{Δ q}{q}}{\frac{Δ p}{p}} = \frac{p}{q} \cdot \frac{Δ q}{Δ p} \qquad Equation 2$$

### Where

ε is the elasticity coefficient,

q is the quantity,

p is the price.

Elasticity coefficient c indicates the relative change in demand of a product or service resulting from the change of price. In other word, the more elastic customers are, the more likely they are to shift or remove their demand when the price of electricity goes up. This may be referred to as self-elasticity. In the specific case of electricity, the change in price of one hour may influence the energy consumption for the other 23 hours. We will measure such impact by cross-elasticity.

Self-elasticity is usually negative and the cross elasticity is positive. Both the self-elasticity and the cross-elasticity effect will be displayed by the following Equation 3:

$$\{ \begin{matrix}Δ {q}^{a} = {ɛ}_{a a} Δ {p}^{a} \\ Δ {q}^{a} = {ɛ}_{a b} Δ {p}^{b}\end{matrix} \\ \\ ( \begin{matrix}Δ {q}^{a} \\ Δ {q}^{b}\end{matrix} ) = ( \begin{matrix}{ɛ}_{a a} & {ɛ}_{a b} \\ {ɛ}_{b a} & {ɛ}_{b b}\end{matrix} ) ( \begin{matrix}Δ {p}^{a} \\ Δ {p}^{b}\end{matrix} ) \qquad Equation 3$$

Therefore, it is possible to calculate the change in demand at hour i by using the elasticity matrix if a determination is made as to much price is desired to deviate from a current price, and vice-versa. In the elasticity matrix, the diagonal elements represent the self-elasticity and the rest represent the cross-elasticity. Using Equation 4 below, Δqᵢ can be calculated:

Δqᵢ=Σₕ₌₁²⁴εᵢₕΔpₕ

ΔQ=EΔP Equation 4

where

ΔQ represents the change in demand vector,

ΔP represents change in price vector, and

E is the elasticity matrix for 24 hours.

From the elasticity matrices, a determination may be made as to how the change in the price of hour k will influence the demand in the other 23 hours from the numbers of column k.

The consumer grouper groups consumers into categories of clusters. The clustering is based on the price elasticity matrices. A consumers is placed in, for example, 1 of 5 categories based on characteristics of his/her matrix, as listed in Table 1 below:

TABLE 1

| Category | Elasticity matrix characteristics | Consumer impact |
|---|---|---|
| 1 | Most non-zero elements are | Bring forward consumption |
| | located above the diagonal of the | when price rises. For |
| | matrix. | example, such a consumer |
| | | would reschedule |
| | | consumption to an earlier |
| | | time. |
| 2 | Most non-zero elements are | Opposite of category 1. |
| | located below the diagonal of the | For example, such a |
| | matrix. | consumer would reschedule |
| | | consumption to a later time |
| | | when price rises earlier time. |
| 3 | Most non-zero elements are | Reschedule consumption |
| | distributed widely away from the | over a long period of time. |
| | diagonal of the matrix | |
| 4 | Most non-zero elements are | Consumption habits remains |
| | clustered along the diagonal of | about the same. |
| | the matrix | |
| 5 | Others | Consumption increases with |
| | | decrease in price. |
| | | For example, such a |
| | | consumer would reschedule |
| | | consumption at the time |
| | | where price is the lowest. |

Providing other number of consumer groups may also be useful.

Once the classification is done by the consumer grouper, the group matrix generator calculates representative matrices for the consumer groups. For example, a representative price elasticity matrix is calculated for each consumer group. In one implementation, a representative matrix is calculate based on total consumption of the consumer group in the period, such as 24 hours. The total consumption of a group can be derived from the demand vectors of consumers in the group. In one implementation, the representative matrix is calculated using a weighted average. For example, representative elasticity matrices E_{n,} n ∈ {1,2,3,4,5} for the consumer groups are calculated using a weighted average. The representative elasticity matrices are passed to the Optimizing module.

Optimizing Module

Pricing may be calculated for the consumer groups based on the representative elasticity matrices. For example, a price table may be calculated for a consumer group based on its respective representative elasticity matrix. As such, each group is associated with its price table. A price table includes a price of the product, such as electricity, for different time slots. For example, the period may be segmented into time slots, such as hourly time slots. Segmenting the period into other time slots may also be useful. It is also understood that the time slots need not be of the same length.

To determine the price of electricity at each time slot (one time slot is assumed), a determination is made as to price to control peak demand, and thus reduce peak to average ratio. A price vector for a consumer group can be determined based on Equation 5 below:

P=P₀+ΔP Equation 5

where

P is the new price vector for the next 24 hours,

P₀ is original electricity price for 24 hours, and

ΔP is the adjustment vector of price.

To get the new price table, an adjustment matrix is calculated. Since ΔQ=EΔP, an optimal ΔQ is determined before getting the best adjustment vector of price, where optimal ΔQ can be determined using Equation 6 below:

ΔQ=Q−Q₀ Equation 6

For example, consider that there are n₂ , n₃, n₄, n₅ consumers in category 1, 2, 3, 4, 7 respectively. Based on demand vectors, consumption may be calculated for all consumers of each category for the designated period, such as 24 hours. Let N denote the set of categories and H denote the set of hours, where n ∈ {1, 2, 3, 4, 5} and hour h ∈ H [symbol] {1,2 . . . 24}. The electricity consumption for all consumers in each category for every hour of the day at hour h may be denoted by dₙₕ [symbol] {d₁₁, d₁₂ . . . d₁₂₄ . . . d₅₁, d₅₂ . . . d₅₂₄}.

Therefore, the vector of daily consumption for consumers across all consumers in category n is denoted by Dⁿ [symbol] {D¹, D², D³, D⁴, D⁵}, where Dⁿ is from equation 7 as follows:

$${D}^{n} = ( \begin{matrix}{d}_{n 1} \\ ⋮ \\ {d}_{n 24}\end{matrix} ) \qquad Equation 7$$

The daily consumption for all consumers at hour h is denoted by D by Dₕ [symbol] {D₁, D₂, D₃ . . . D₂₃, D₂₄}. Based on these definitions, the daily consumption for all consumers at hour h can be calculated using Equation 8:

$${D}_{h} = {\sum }_{n ∈ N} {d}_{nh} \qquad Equation 8$$

The average consumption level in 24 hours can be calculated using Equation 9 while the total variance of 24 hours are calculated using Equation 10 below:

$${D}_{avg} = \frac{{\sum }_{h = 1}^{24} {D}_{h}}{24} \qquad Equation 9$$

$$Total Variance = \frac{1}{24} {\sum }_{h = 1}^{24} ( {D}_{h} - {D}_{avg} ) \qquad Equation 10$$

Minimizing the peak or optimization, can be expressed using Equation 11 below:

$$Minimize \frac{1}{24} {\sum }_{h = 1}^{24} {( {D}_{h} - {D}_{avg} )}^{2} \qquad Equation 11$$

For example, the optimization function is to minimize the total variance.

In general, to provide enough incentives for providers to follow an optimized pricing schedule, the above optimization function should satisfy the constraint that the profit of the company following the optimized pricing schedule will be no less than the initial profit, which is expressed using Equation 12:

Profit−Profit₀≧0 Equation 12

where

Profit denotes the adjusted profit, and

Profit₀ denotes the initial profit.

The initial profit Profit₀ can be defined using Equation 13 while Profit can be defined by Equation 14 below:

$$\begin{matrix}\begin{matrix}{Profit}_{0} = {Revenue}_{0} - {Cost}_{0} \\ = {\sum }_{n = 1}^{5} {P}_{0} * {( {D}_{0}^{n} )}^{T} - {C}_{0}\end{matrix} & Equation 13 \\ \begin{matrix}Profit = Revenue - Cost \\ = P * Q - C \\ = ( {P}_{0} + Δ P ) * ( {Q}_{0} + Δ Q ) - C \\ = {\sum }_{n = 1}^{5} ( {P}_{0} + {E}_{n}^{- 1} Δ {Q}_{n} ) * {Q}_{n} - C \\ = {\sum }_{n = 1}^{5} ( {P}_{0} + {E}_{n}^{- 1} ( {D}^{n} - {D}_{0}^{n} ) ) * {( {D}^{n} )}^{T} - C\end{matrix} & Equation 14\end{matrix}$$

where

C represents the cost of generating electricity,

C₀ denotes the initial cost, and

C denotes the adjusted cost.

The cost function C can be defined as C(D), indicating that the cost of generating and distributing electricity is related to the vector of demand at each hour. The demand vector can be expressed as follows:

$$( \begin{matrix}{D}_{1} \\ ⋮ \\ {D}_{24}\end{matrix} ) .$$

Generation can be scheduled using a unit commitment program. Knowing the vector of demand at each hour, the minimum generation cost can be calculated. Therefore this constraint or lower boundary can be simplified as Equation 15 below:

Σₙ₌₁⁵ Eₙ⁻¹(Dⁿ−D₀ⁿ)*(Dⁿ)^{T}−(C(D)−C(D₀))≧0 Equation 15

There may be an upper boundary vector Pₘ for the price. The upper boundary may be due to, for example, regulations governing the maximum price of the product, such as electricity. The upper boundary may be expressed by Equation 16 below:

P≦Pₘ Equation 16

The upper boundary can be written as the expression of a demand vector as Equation 17 below:

P₀+Eₙ⁻¹(Dⁿ−D₀ⁿ)≦Pₘ n ∈ {1, 2, 3, 4, 5} Equation 17

where n represents the category.
Moreover, demand of each category at each hour should be non-negative, as provided for in Equation 18 below:

dₙₕ≧0 Equation 18

Assuming that the maximum generation capacity is m, then demand must be less than or equal to m, as defined by the following Equation 19.

$${D}_{h} \leq m \\ where {D}_{h} = {\sum }_{n ∈ N} {d}_{nh} \qquad Equation 19$$

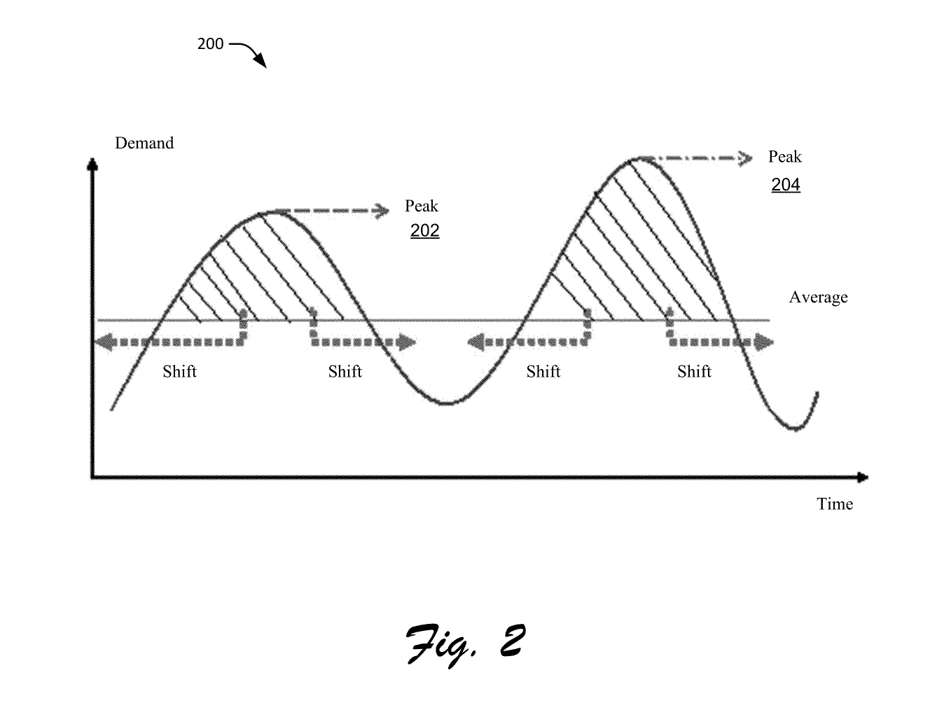

FIG. 2 shows a demand over time curve 200. As the curve 200 shows, a goal is to improve the efficiency of electricity generation and reduce the system risk. To achieve such goals, it is desirable to smooth the demand among the time zone and remove the peaks 202 and 204 as much as possible. Therefore, the optimizing function is to minimize the total variance of demand among different hours subject to constraints, as indicated by equation 20 below:

$$Minimize {f}_{( {d}_{nh} )} = \frac{1}{24} {\sum }_{h = 1}^{24} {( {D}_{h} - {D}_{avg} )}^{2}$$

### Subject to:

$${\sum }_{n = 1}^{5} {E}_{n}^{- 1} ( {D}^{n} - {D}_{0}^{n} ) * {( {D}^{n} )}^{T} - ( C ( D ) - C ( {D}_{0} ) ) \geq 0 ; \\ {d}_{nh} \geq 0 \\ {D}_{h} \leq m \\ where {d}_{nh} {=}^{△} \{ {d}_{11} , {d}_{12} … {d}_{124} … {d}_{51} , {d}_{52} … {d}_{524} \} . \\ {D}_{h} = {\sum }_{n ∈ N} {d}_{nh} \\ {D}_{avg} = \frac{{\sum }_{h = 1}^{24} {D}_{h}}{24} \\ {D}^{n} = ( \begin{matrix}{d}_{n 1} \\ ⋮ \\ {d}_{n 2}\end{matrix} ) \\ where n ∈ \{ 1 , 2 , 3 , 4 , 5 \} \qquad Equation 20$$

The optimizing function, as described, is a QCQP. The analyzer is used to solve the optimizing function. In one implementation, the analyzer includes a GA analyzer for performing a GA. The GA analyzer, in one implementation, includes a chromosome encoder, an initializer, an evaluator and a mutator. The GA analyzer imitates the process of natural selection. In a genetic algorithm, a population of to an optimization problem is evolved toward better solutions. Other types of analyzers, such as BB or heuristic analyzers may also be useful to solve the optimizing function.

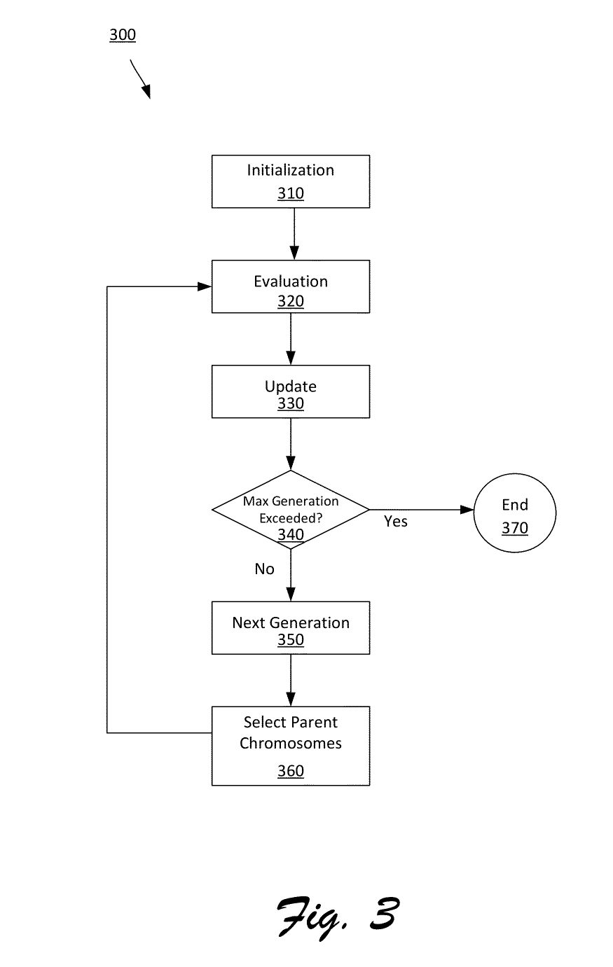

FIG. 3 shows an example process 300 for a GA analyzer. The GA analyzer at step 302, performs initialization. For example, initializer performs initialization. Initialization includes generating initial chromosomes. In one implementation, initial chromosomes are demand vectors. Demand vectors, for example, are expressed by following Equation 21

$${D}^{n} = ( \begin{matrix}{d}_{n 1} \\ ⋮ \\ {d}_{n 2}\end{matrix} ) , n ∈ \{ 1 , 2 , 3 , 4 , 5 \} \qquad Equation 21$$

A demand vector is associated with each consumer group. Each element of a demand vector is in the range between zero and the total demand at each hour is below the maximum generation capacity m.

Furthermore, a demand vector should satisfy constraints. In one implementation, the constraints, as discussed, may be Equation 15 and Equation 17 provided below:

Σₙ₌₁⁵ Eₙ⁻¹(Dⁿ−D₀ⁿ)*(Dⁿ)^{T}−(C(D)−C(D₀))≧0 Equation 15

P₀+Eₙ⁻¹(Dⁿ−D₀ⁿ)≦Pₘ where n ∈ {1, 2, 3, 4, 5} Equation 17

The initial chromosomes are evaluated at step 304. For example, the evaluator evaluates the initial chromosomes. Evaluation includes setting the optimizing function as a fitness function for evaluation, as described by Equation 22 below:

$$Fitness = Total Variance = \frac{1}{24} {\sum }_{h = 1}^{24} ( {D}_{h} - {D}_{avg} ) . \qquad Equation 22$$

For example, the smaller the variance, the better the chromosomes are

At step 306, parent chromosomes are selected. Parent chromosomes are chromosomes from the group of initial chromosomes which satisfies the constraints of the optimizing equation. The selected chromosomes are fit chromosomes based on the fitness function.

At step 308, next generation chromosomes are generated. The next generation chromosomes are generated by the mutator. For example, the mutator use crossover and mutation techniques to generate the next generation chromosomes. The chromosomes are evaluated at step 310, as previously discussed. The chromosomes are updated at step 310. For example, children chromosomes of chosen parents which satisfy the constraints are added to the pool of chromosomes. The process continues to steep 314 to determine whether the process has exceeded the maximum number of generation of chromosomes. The maximum number, for example, is selected by the user. The number, for example, may depend on the time and computational resources. The larger the number, the longer the analysis process. If the process has not exceeded the maximum number of generations, it returns to step 306, where parent chromosomes are selected. On the other hand, if the process exceeded the maximum number of generations, the process proceeds to step 314 and terminates. The result is a set of price vectors.

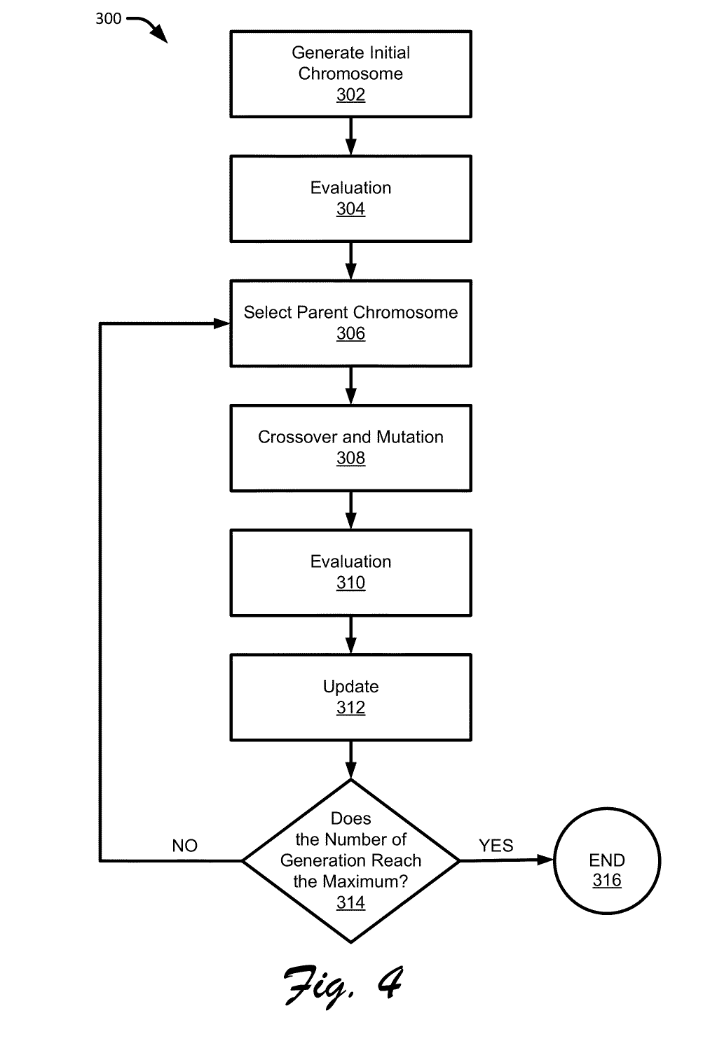

FIG. 4 shows an exemplary initialization process 400. For example, the initialization process is performed by the initializer of the analyzer. At step 402, a demand vector is randomly generated. A vector is generated for each group. For example, 5 vectors are generated. The process determines if the vector satisfies all constraints at step 404. If the vector satisfies the constraint, it is added to the candidate pool. At step 408, the process determines if there are additional vectors to generate. For example, the process determines if the number of candidates reached a predefined value. If the number of candidates has reached the predefined value, the process terminates. Otherwise, the process returns to step 402.

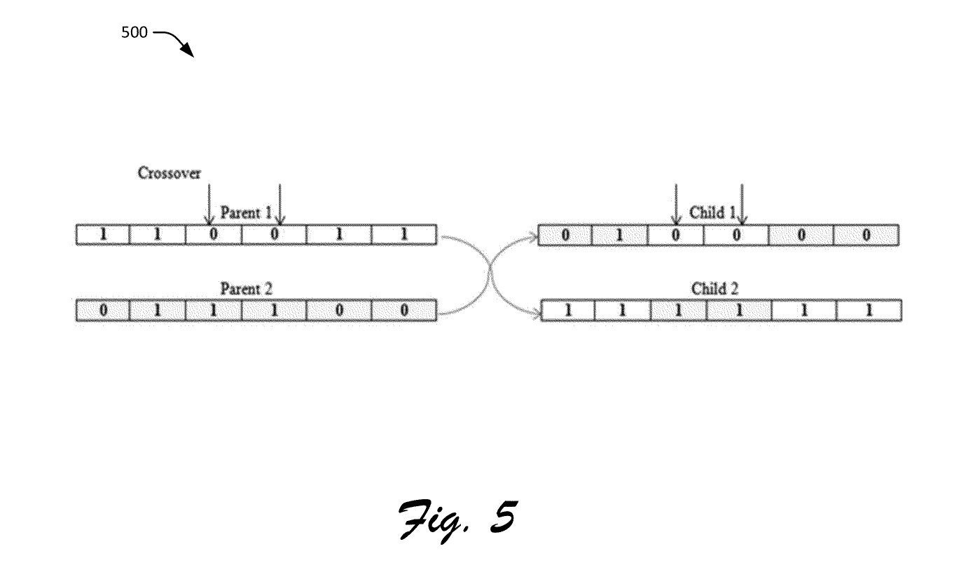

FIG. 5 illustrates crossover and mutation process 500. The crossover and mutation process, for example, is performed by the mutator. A next generation population is generated from selected parent chromosomes through a combination of genetic operators. For example, two individuals are selected from “parent 1” 502 and “parent 1” 504. A crossover site along the bit strings is randomly chosen. Then the values of two strings exchanged up to the point. Two offsprings, “child 1” 506 and “child 2” 508 are created from this mating and added to the next generation. Mutation involves flipping selected genes of a chromosome. There is a low probability that a proportion of the new children will have some of their bits flipped.

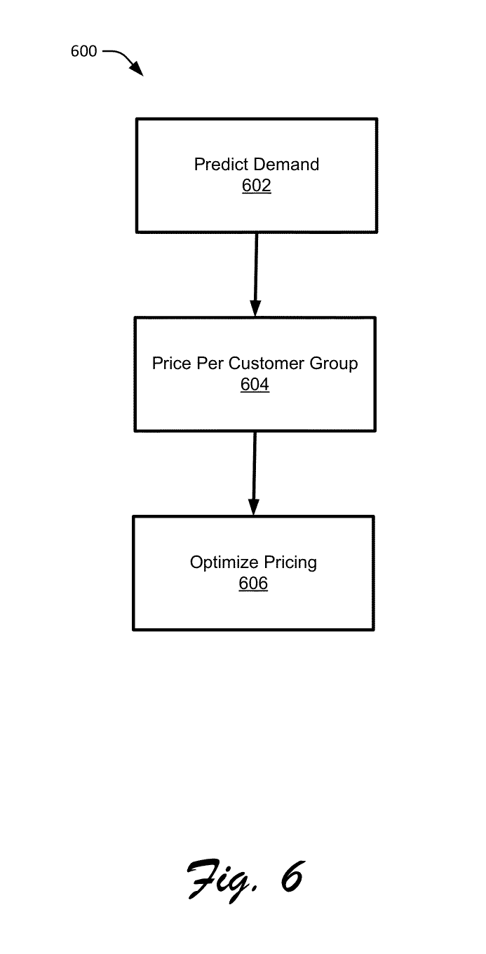

FIG. 6 shows an exemplary process 600 for designing a price plan and managing demand for a product. The process 600 may be performed by a computing device. At step 602, predicting demand is performed. Demand may be predicted over a future time period, such as over the next 24 hour period. Demand may be predicted for each customer. Predicting only a sample of the customers may also be useful. The demand may be predicted using a demand model. The demand model, for example, is an autoregressive integrated moving average (ARIMA) time series regression model. Other types of models may also be useful

The process performs customer groupings and generating representative price elasticity matrices for the different customer groups at step 506. This, for example, includes generating individual customer price elasticity matrices for each customer and grouping customers based on the matrices. For example, customers may be grouped due to similar characteristics in the matrices. Representative price elasticity matrices are then generated for the customer groups.

At step 606 price optimizing is performed for demand management. In one embodiment, an optimizing function is developed. The optimizing function, for example, minimizes fluctuations in demand, such as hourly fluctuations. Other types of functions, such as focusing demand in certain periods may also be useful. In one embodiment, the optimizing function is solved using GA. Other techniques for solving the optimizing function may also be useful. Solving the optimizing function results in price vectors to achieve the desire demand curve. For example, the price vectors result in the desire time-demand curve.

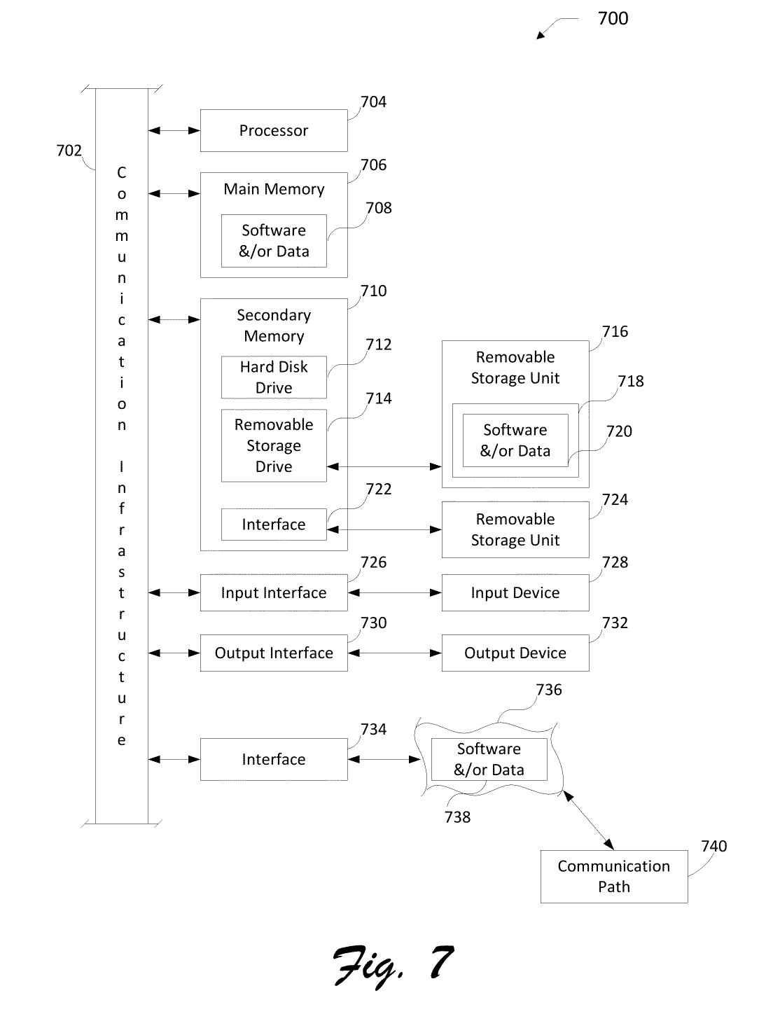

FIG. 7 illustrates an exemplary system 700 that may implement, at least in part, the technologies described herein. The computer system 700 includes one or more processors, such as processor 704. Processor 704 can be a special-purpose processor or a general-purpose processor. Processor 704 is connected to a communication infrastructure 702 (for example, a bus or a network). Depending upon the context, the computer system 700 may also be called a client device.

Computer system 700 also includes a main memory 706, preferably Random Access Memory (RAM), containing possibly inter alia computer software and/or data 708.

Computer system 700 may also include a secondary memory 710. Secondary memory 710 may include, for example, a hard disk drive 712, a removable storage drive 714, a memory stick, etc. A removable storage drive 714 may comprise a floppy disk drive, a magnetic tape drive, an optical disk drive, a flash memory, or the like. A removable storage drive 714 reads from and/or writes to a removable storage unit 716 in a well-known manner. A removable storage unit 716 may comprise a floppy disk, a magnetic tape, an optical disk, etc. which is read by and written to by removable storage drive 714. As will be appreciated by persons skilled in the relevant art(s) removable storage unit 716 includes a computer usable storage medium 718 having stored therein possibly inter alia computer software and/or data 720.

In alternative implementations, secondary memory 710 may include other similar means for allowing computer programs or other instructions to be loaded into computer system 700. Such means may include, for example, a removable storage unit 724 and an interface 722. Examples of such means may include a program cartridge and cartridge interface (such as that found in video game devices), a removable memory chip (such as an Erasable Programmable Read-Only Memory (EPROM), or Programmable Read-Only Memory (PROM)) and associated socket, and other removable storage units 724 and interfaces 722 which allow software and data to be transferred from the removable storage unit 724 to computer system 700.

Computer system 700 may also include an input interface 726 and a range of input devices 728 such as, possibly inter alia, a keyboard, a mouse, etc. Computer system 700 may also include an output interface 730 and a range of output devices 732 such as, possibly inter alia, a display, one or more speakers, etc.

Computer system 700 may also include a communications interface 734. Communications interface 734 allows software and/or data 738 to be transferred between computer system 700 and external devices. Communications interface 734 may include a modem, a network interface (such as an Ethernet card), a communications port, a Personal Computer Memory Card International Association (PCMCIA) slot and card, or the like. Software and/or data 738 transferred via communications interface 734 are in the form of signals 736 which may be electronic, electromagnetic, optical, or other signals capable of being received by communications 734. These signals 736 are provided to communications interface 734 via a communications path 740. Communications path 740 carries signals and may be implemented using a wire or cable, fiber optics, a phone line, a cellular phone link, a Radio Frequency (RF) link or other communication channels.

As used in this document, the terms “computer-program medium,” “computer-usable medium,” and “computer-readable medium” generally refer to media such as removable storage unit 716, removable storage unit 724, and a hard disk installed in hard disk drive 712. Computer program medium and computer usable medium can also refer to memories, such as main memory 706 and secondary memory 710, which can be memory semiconductors (e.g. Dynamic Random Access Memory (DRAM) elements, etc.). These computer program products are means for providing software to computer system 700.

Computer programs (also called computer control logic) are stored in main memory 706 and/or secondary memory 710. Such computer programs, when executed, enable computer system 700 to implement the present technology described herein. In particular, the computer programs, when executed, enable processor 704 to implement the processes of aspects of the above. Accordingly, such computer programs represent controllers of the computer system 700. Where the technology described herein is implemented, at least in part, using software, the software may be stored in a computer program product and loaded into computer system 700 using removable storage drive 714, interface 722, hard disk drive 712 or communications interface 734.

The technology described herein may be implemented as computer program products comprising software stored on any computer useable medium. Such software, when executed in one or more data processing devices, causes data processing device(s) to operate as described herein. Embodiments of the technology described herein may employ any computer useable or readable medium, known now or in the future. Examples of computer useable mediums include, but are not limited to, primary storage devices (e.g., any type of random access memory), secondary storage devices (e.g., hard drives, floppy disks, Compact Disc Read-Only Memory (CD-ROM) disks, Zip disks, tapes, magnetic storage devices, optical storage devices, Microelectromechanical Systems (MEMS), and nanotechnological storage device, etc.).

A computing system may take the form of any combination of one or more of inter alia a wired device, a wireless device, a mobile phone, a feature phone, a smartphone, a tablet computer (such as for example an iPad™), a mobile computer, a handheld computer, a desktop computer, a laptop computer, a server computer, an in-vehicle (e.g., audio, navigation, etc.) device, an in-appliance device, a Personal Digital Assistant (PDA), a game console, a Digital Video Recorder (DVR) or Personal Video Recorder (PVR), a cable system or other set-top-box, an entertainment system component such as a television set, etc.

In the above description of exemplary implementations, for purposes of explanation, specific numbers, materials configurations, and other details are set forth in order to better explain the present invention, as claimed. However, it will be apparent to one skilled in the art that the claimed invention may be practiced using different details than the exemplary ones described herein. In other instances, well-known features are omitted or simplified to clarify the description of the exemplary implementations.

The inventors intend the described exemplary implementations to be primarily examples. The inventors do not intend these exemplary implementations to limit the scope of the appended claims. Rather, the inventor has contemplated that the claimed invention might also be embodied and implemented in other ways, in conjunction with other present or future technologies.

Moreover, the word “exemplary” is used herein to mean serving as an example, instance, or illustration. Any aspect or design described herein as exemplary is not necessarily to be construed as preferred or advantageous over other aspects or designs. Rather, use of the word “exemplary” is intended to present concepts and techniques in a concrete fashion. The term “technology,” for instance, may refer to one or more devices, apparatuses, systems, methods, articles of manufacture, and/or computer-readable instructions as indicated by the context described herein.

As used in this application, the term “or” is intended to mean an inclusive “or” rather than an exclusive “or.” That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more,” unless specified otherwise or clear from context to be directed to a singular form.

Note that the order in which the processes are described is not intended to be construed as a limitation, and any number of the described process blocks can be combined in any order to implement the processes or an alternate process. Additionally, individual blocks may be deleted from the processes without departing from the spirit and scope of the subject matter described herein.

One or more embodiments described herein may be implemented fully or partially in software and/or firmware. This software and/or firmware may take the form of instructions contained in or on a non-transitory computer-readable storage medium. Those instructions may then be read and executed by one or more processors to enable performance of the operations described herein. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as but not limited to read only memory (ROM); random access memory (RAM); magnetic disk storage media; optical storage media; a flash memory, etc.

1. A computer-implemented method for demand management comprising:
generating demand vectors of consumers by a demand model module;
calculating price elasticity matrices for consumers by a pricing model unit;
grouping consumers into consumer groups based on price elasticity matrices;
generating representative price elasticity matrices for the consumer groups;
constructing an optimizing function; and
solving the optimizing function to produce price vectors to set pricing for the consumer groups to manage demand based on pricing.

2. The computer-implemented method of claim 1, wherein generating demand vectors comprises a multiple regression module unit of the demand model module.

3. The computer-implemented method of claim 2, wherein:
the multiple regression module generates demand vectors for customers for a next period of time; and
the price vectors set pricing for time slots in the next period of time.

4. The computer-implemented method of claim 2, wherein:
the next period of time comprises 24 hours; and
time slots comprise hourly time slots.

5. The computer-implemented method of claim 1, wherein elasticity matrices for customers are calculated using historical data.

6. The computer-implemented method of claim 5, wherein representative matrices for consumer groups are calculated using a weighted average based on a total consumption of the respective consumer groups.

7. The computer-implemented method of claim 1, wherein solving the optimizing function comprises a heuristic analysis.

8. The computer-implemented method of claim 1, wherein solving the optimizing function comprises a genetic algorithm (GA) analysis.

9. The computer-implemented method of claim 8 wherein the GA analysis comprises:
initializing the process,
by generating chromosomes from the demand vectors, the chromosomes serve as initial chromosomes, and
creating a chromosome pool which is empty, evaluating the chromosomes to select fit chromosomes, the fit chromosomes
are added to the chromosome pool;
a) selecting parent chromosomes from the chromosome pool
b) performing cross-over and mutation from chromosomes in the chromosome pool to generate next generation chromosomes;
c) evaluating the next generation chromosomes to select fit next generation chromosomes;
d) updating to add fit next generation chromosomes to the chromosome pool; and
e) repeating a-d until a number of generations reaches a maximum defined number.

10. The computer-implemented method of claim 9 wherein evaluating comprises setting the optimizing function as a fitness function.

11. The computer-implemented method of claim 1 wherein each consumer group comprises a respective price vector from solving the optimizing function.

12. A demand management system comprising:
a demand prediction module, the demand prediction module includes a multiple regression model unit to generate demand vectors predicting demand of consumers;
a pricing model module includes a consumer grouping unit, the consumer grouping unit
groups consumers into consumer groups based on individual price elasticity matrices, and
calculates representative price elasticity matrices for the consumer groups;
an optimization module, the optimization module includes an optimizer unit for solving an optimizing function to generate price vectors to set pricing for the consumer groups to manage demand based on pricing.

13. The system of claim 12, wherein:
the demand prediction module generates demand vectors for customers for a next period of time; and
the price vectors set pricing for time slots in the next period of time.

14. The system of claim 13, wherein:
the next period of time comprises 24 hours; and
time slots comprise hourly time slots.

15. The system of claim 12, wherein the consumer grouping unit comprises:
an individual matrix generator, the individual matrix generator calculates the individual elasticity matrices for consumers;
a consumer grouper, the consumer grouper groups consumers based on the individual elasticity matrices of the consumers;
a group matrix generator, the group matrix generator calculates the representative matrices of the consumer groups.

16. The system of claim 15, wherein the consumer grouper groups consumers based on location of non-zero elements in the individual price elasticity matrices.

17. The system of claim 12, wherein the optimizer unit comprises a heuristic analyzer for solving the optimizing function.

18. The system of claim 17, wherein the heuristic analyzer comprises a genetic algorithm (GA) analyzer with:
a chromosome encoder;
an initializer; and
a mutator,

19. A non-transitory computer-readable medium having stored thereon program code, the program code executable by a computer for providing demand management based on pricing comprising:
generating demand vectors of consumers for a next period of time by a demand model module with a multiple regression module unit of the demand model module;
calculating price elasticity matrices for consumers by a pricing model unit;
grouping consumers into consumer groups based on price elasticity matrices;
generating representative price elasticity matrices for the consumer groups;
constructing an optimizing function; and
solving the optimizing function to produce price vectors to set pricing for the consumer groups for time slots in the next period of time to manage demand based on pricing.

20. The non-transitory computer-readable medium of claim 19, wherein solving the optimizing function comprises a heuristic analysis.
